(19) United States
(12) Patent Application Publication
(10) Pub. No.: US 2003/0016658 A1
(43) Pub. Date: Jan. 23, 2003

(54) E-mail with voice conversation feature

(75) Inventors: Thomas E. Creamer, Boca Raton, FL (US); Victor S. Moore, Boynton Beach, FL (US); Glen R. Walters, Hollywood, FL (US)

Correspondence Address: Gregory A. Nelson, Akerman Senterfitt, 222 Lakeview Avenue, Fourth Floor, P.O. Box 3188, West Palm Beach, FL, 33402-3188, US

(73) Assignee: International Business Machines Corporation, Armonk, NY

(21) Appl. No.: 09/910,270

(22) Filed: Jul. 19, 2001

(51) Int. Cl. H04L 12/66

(52) U.S. Cl. 370/352; 379/88.17

(57) ABSTRACT

An e-mail communication method. An e-mail communication method can include the steps of: detecting a voice communications identifier in an e-mail message transmitted by a sender; responsive to detecting the voice communications identifier, displaying a selectable icon; and, responsive to a selection of the icon, establishing a voice communications link with the sender. The establishing step can include the step of, responsive to the recipient selecting the voice communications identifier, establishing a Voice over IP (VoIP) based voice communications link with the recipient. Alternatively, the establishing step can include the step of, responsive to the recipient selecting the voice communications identifier, establishing a telephony-based voice communications link with the recipient over a public switched telephone network (PSTN).

### BACKGROUND OF THE INVENTION

1. Technical Field

This invention relates generally to an electronic mail system, and more particularly to an electronic mail system enhanced with two-way voice communications capabilities.

2. Description of the Related Art

Electronic mail (e-mail) systems have become a fixture of current computer communications technology. E-mail provides a low cost, efficient, and effective means for exchanging text messages between sending and receiving clients. Conventional e-mail messages typically are contained in electronic documents which can be transmitted from a sending mail server to a recipient mail server. In particular, the sending client can create and appropriately format an e-mail and transmit the e-mail to a specified mail server. The mail server can examine the contents of the e-mail to determine to whom the e-mail should be forwarded. Subsequently, the e-mail can be transmitted to a mail server associated with the intended recipient.

Once the e-mail has been successfully transmitted to the recipient mail server, the recipient mail server can store the received e-mail typically in an electronic “inbox”. Subsequently, the intended recipient can retrieve the e-mail from the mail server on demand. Once retrieved, the contents of the e-mail can be revealed through the presentation of the e-mail message text to the recipient. Additionally, other information contained in the e-mail such as the identity of the sender, the subject of the e-mail message and the date and time when the e-mail had been transmitted also can be presented to the user. Hence, conventional e-mail messages can contain not only message text, but also message header information.

Conventional e-mail systems also can support the exchange of e-mail attachments. Attachments are electronic files such as images, documents or binary objects which can be attached to an e-mail and transmitted therewith from a sender to a recipient. Attachments can be embedded in a labeled section of an e-mail such that an e-mail client processing the e-mail can identify the presence of an attachment and can decode the contents of the attachment so that the attachment can be further processed by the recipient. Hence, attachments can enhance the utility of exchanging e-mail.

Still, e-mail and e-mail attachments are not always an adequate replacement for live voice conversations between two parties, particularly where extensive interaction between the participants is necessary or desirable. In some instances, such conversations are necessary to explain or discuss the message text included in the email, attached documents or audio/visual files. Moreover, a telephone sometimes is not available to the parties, or the use of a telephone requires lengthy dialing procedures which interrupts the spontaneity of the communication. Sometimes telephone access by the parties requires that at least one of the parties terminate an on-line connection to the Internet, which can disrupt the process of discussing the contents of an e-mail.

### SUMMARY OF THE INVENTION

The present invention is a e-mail processing system and method and an electronic message article of manufacture for use therewith. From the perspective of a person sending an electronic message to one or more recipients, an e-mail communication method in accordance with the inventive arrangements can include the steps of: inserting in an e-mail message a voice communications identifier; transmitting the e-mail message to a recipient; and, responsive to the recipient selecting the voice communications identifier, establishing a voice communications link with the recipient.

The establishing step can include the step of responsive to the recipient selecting the voice communications identifier, establishing a Voice over IP (VoIP) based voice communications link with the recipient. Alternatively, the establishing step can include the step of, responsive to the recipient selecting the voice communications identifier, establishing a telephony-based voice communications link with the recipient over a public switched telephone network (PSTN).

The inserting step can further include the step of inserting in the e-mail message a selectable symbol denoting voice communications availability. Moreover, the inserting step can further include the steps of: inserting in the e-mail message a reference to a sender of the e-mail message; and, embedding computer program code in the e-mail message, wherein the computer program code is configured to establish a voice communications link with the sender. In that case, the establishing step can include the step of, responsive to the recipient selecting the voice communications identifier, executing the embedded computer program code in order to establish a voice communications link with the sender.

The establishing step can include the steps of, responsive to the recipient selecting the voice communications identifier, determining a link address for the sender based on the reference, and executing the embedded computer program code in order to establish a voice communications link with the sender according to the determined link address. Notably, the link address can be a telephone number. Also, the link address can be an IP address.

By comparison, from the perspective of a recipient node receiving an e-mail transmitted by a sending node, an e-mail communication method can include the steps of: detecting a voice communications identifier in an e-mail message transmitted by a sender; responsive to detecting the voice communications identifier, displaying a selectable icon; and, responsive to a selection of the icon, establishing a voice communications link with the sender. The establishing step can include the step of, responsive to the recipient selecting the voice communications identifier, establishing a Voice over IP (VoIP) based voice communications link with the recipient. Alternatively, the establishing step can include the step of, responsive to the recipient selecting the voice communications identifier, establishing a telephony-based voice communications link with the recipient over a public switched telephone network (PSTN).

Notably, the establishing step can include the steps of: extracting from the email message embedded computer program code configured to establish a voice communications link with the sender; and, responsive to the selection of the icon, executing the embedded computer program code in order to establish a voice communications link with the sender. Also, an embedded reference to the sender can be extracted from the e-mail message. In that case, the executing step can further include the steps of: determining a link address for the sender based on the extracted reference; and, executing the embedded computer program code in order to establish a voice communications link with the sender according to the determined link address. Notably, the link address can be a telephone number. Also, the link address can be an IP address.

The invention also contemplates the transmission of an e-mail to multiple recipients. In that case, the method can further include the steps of extracting from the e-mail message embedded references to the sender and at least one other recipient of the e-mail message; and, displaying a corresponding selectable icon for each of the at least one other recipients. Additionally, responsive to a selection of one of the selectable icons, a corresponding recipient can be identified and a link address can be determined for the corresponding recipient based on the extracted reference; and, the embedded computer program code can be executed in order to establish a voice communications link with the corresponding recipient according to the determined link address. Finally, responsive to a selection of two or more of the selectable icons, a corresponding recipient can be identified for each selected icon and a link address determined for the corresponding recipients based on the extracted references; and, the embedded computer program code can be executed in order to establish a conference call with the corresponding recipients according to the determined link addresses.

In accordance with the inventive arrangements, electronic messages can be created, transmitted and parsed in the computer communications network. An electronic message article of manufacture for use in the computer communications network can include a message header component encapsulating a reference to at least one of a sending node in the network and a recipient node in the network; a text message component encapsulating message text which can be extracted from the electronic message and displayed in a message client; and, an executable voice communications link program component configured to establish a voice communications link between the sending and recipient nodes. The voice communications link can be a Voice over IP (VoIP) based communications link. Alternatively, the voice communications link can be a telephony-based link

Also in accordance with the inventive arrangements, electronic messages can be processed in e-mail clients. An e-mail client configured to process an electronic message can include a conventional e-mail processor, the conventional e-mail processor extracting and displaying message text encapsulated in a received e-mail; and, a voice conversation processor, the voice conversation processor identifying a voice communications link identifier encapsulated in the received e-mail, displaying a selectable icon in response to detecting the voice communications link identifier and, responsive to a selection of the selectable icon, establishing a voice communications link with a sender of the received e-mail.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a schematic diagram of a network based electronic mail system for use in the present invention.

FIG. 2 is a block diagram of an e-mail client processing electronic mail configured with a voice conversation feature in accordance with the inventive arrangements.

### DETAILED DESCRIPTION OF THE PREFERRED EMBODIMENT

The present invention is an e-mail communications method and system for processing an electronic message which has been configured in accordance with the inventive arrangements. The method can include both a sender inserting in the electronic message a voice communications identifier and the sender transmitting the message to a recipient. The recipient can detect the voice communications identifier in the e-mail message and, in addition to displaying message text contained in the message, the recipient can display a selectable icon. Responsive to the selection of the icon, a voice communications link can be established between the sender and the recipient. In particular, the voice communications link can be a Voice over IP (VoIP) based voice communications link over the computer communications network, or a telephony-based voice communications link over a public switched telephone network (PSTN).

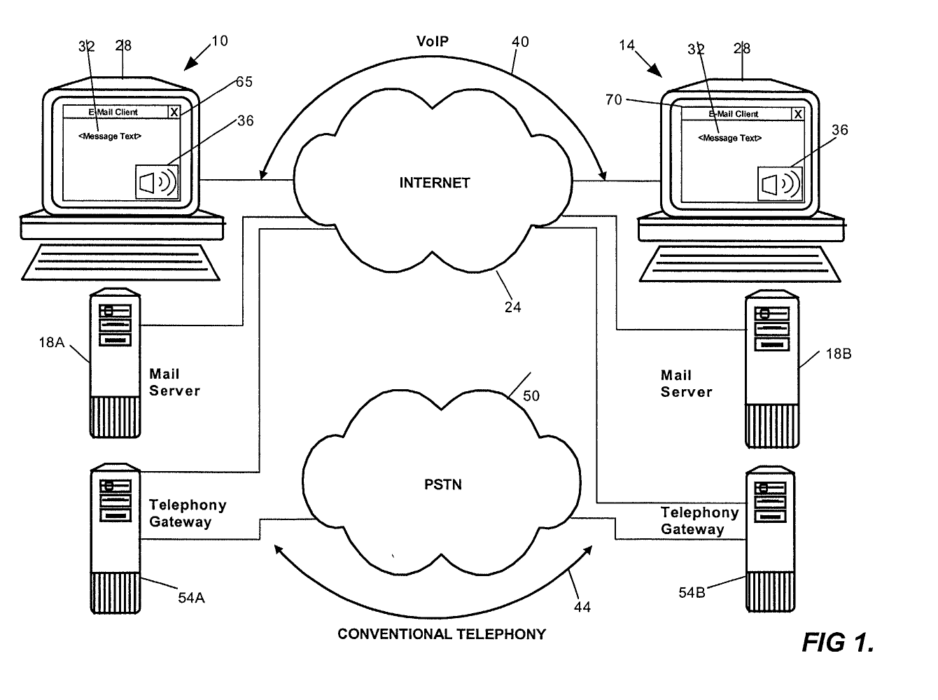

An exemplary network based electronic mail system according to the invention is shown in FIG. 1. A first e-mail client 65 in a sending node 10 and a second e-mail client 70 in a recipient node 14 are shown although the invention can be utilized with any number and configuration of e-mail clients acting as both sending and recieving nodes. In one exemplary case illustrated in FIG. 1, however, e-mail messages can be transmitted and received by the first e-mail client 65 over a computer communications network such as the Internet 24 through a mail server 18A. Similarly, e-mail messages can be transmitted and received by the second e-mail client 70 over a computer communications network such as the Internet 24 through a second mail server 18B. Still, the invention is not limited to a particular mail server configuration and one mail server can be used by both the first and second e-mail clients 65, 70 to send and receive e-mail messages.

Once received, an e-mail message can be parsed and the contents 32 can be displayed in the e-mail client 70 as is well-known in the art. Additionally, information pertaining to the sender, recipient and other pertinent data can be extracted from the email message and optionally displayed in the e-mail client 70. Examples of pertinent data can include references to the sender and one or more recipients such as network IP addresses. Pertinent data also can include a message subject and transmission date and time information.

Importantly, a voice communications identifier can be included in the e-mail message to indicate that a voice communications link can be established between the sending and recipient nodes 10, 14. Upon receipt of an e-mail message, the e-mail client 70 can detect the voice communications identifier when parsing the e-mail message. Responsive to detecting a voice communications identifier in the e-mail message, the e-mail client can display a selectable voice communications icon 36 which can indicate to an e-mail message recipient that a voice communications link can be established between the sending node 10 and the recipient node 14. The icon 36 is preferably displayed within the present message text 32, although alternative placement of the icon 36 is possible. The icon 36 can be any suitable text or graphic symbol, but preferably represents voice communications to a typical viewer.

Selection of the icon 36 by a viewer can cause the establishment of a voice communications link between the recipient node 14 and the sending node 10. In particular, though the voice communications link can be provided through any suitable voice communications technology, in one aspect of the present invention, a voice communications link 40 can be provided over the Internet 24 based upon the Voice over IP (VoIP) protocol. In another aspect of the invention, a voice communications link 44 can be provided using a conventional telephony link 44 provided by conventional telephony gateways 54A, 54B over a public switched telephone network (PSTN) 50.

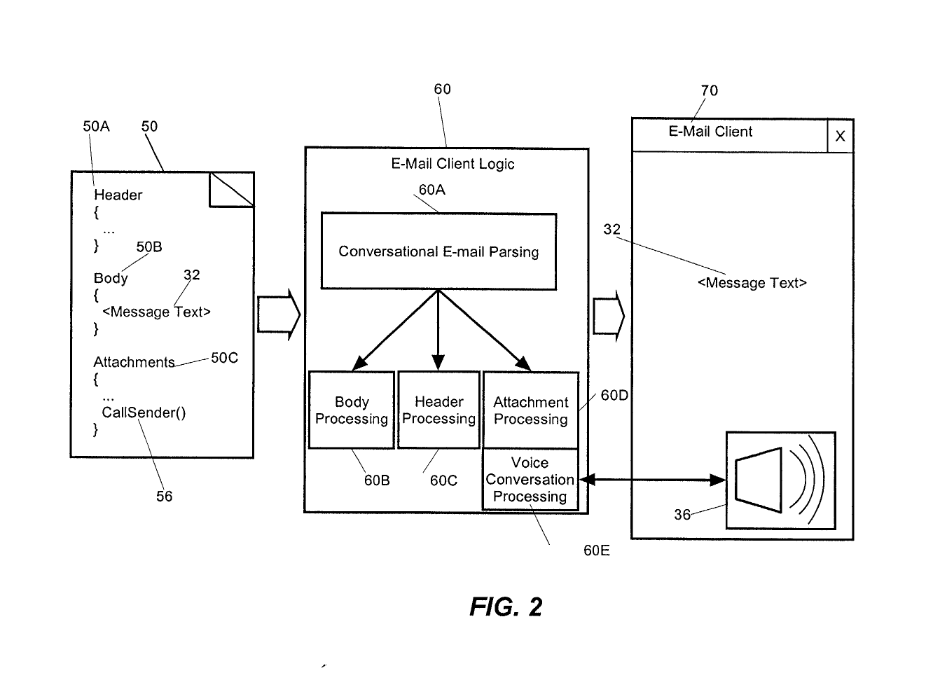

FIG. 2 is a block diagram which illustrates a process sequence in an e-mail client configured in accordance with the present invention. In particular, as shown in FIG. 2 an electronic message 50 can be configured with a voice conversation identifier 56. E-mail client logic 60 can process the electronic message 50 so that the message text 32 can be displayed in the e-mail client 70. E-mail client logic 60 also can process the electronic message 50 so as to detect the voice conversation identifier 56 and to responsively provide a selectable icon 36 in the e-mail client 70.

More particularly, in accordance with the inventive arrangements an electronic message 50 can be configured to include a message header component 50A which can encapsulate a reference to at least one of a sending node in the network and a recipient node in the network. The electronic message 50 also can be configured to include a text message component 50B which can encapsulate message text 32 which can be extracted from the electronic message 50 and displayed in a message client 70. Finally, the electronic message 50 can be configured to include an attachments component 50C which can encapsulate message attachments in addition to a voice communications identifier 56.

Notably, the voice communications identifier 56 can include basic information denoting the ability to establish a voice communications link with the sending node. Notwithstanding, the invention is not limited in this regard and in an alternative aspect of the invention, the voice communications identifier 56 can include an executable voice communications link program component. When executed, the voice communications link program can establish a voice communications link between the sending and recipient nodes.

As will be apparent to one skilled in the art, the voice communications link program component can be implemented using not only a scripting language such as Javascript or VBScript, but also the voice communications link program component can be a compiled object whose binary representation is included in the e-mail message 50. In that case, when extracted from the e-mail message 50, the compiled object can be independently executed without requiring intermediate script interpretation. Finally, it will be apparent to one skilled in the art that the voice communications link program can be a reference to a program residing elsewhere in a computer communications network. Selection of the reference can cause the program to be downloaded and executed in the recipient node.

Returning now to FIG. 2, e-mail client logic 60 associated with the e-mail client 70 can process the e-mail message 50, first by parsing the contents of the e-mail message 50 in an e-mail parsing component 60A. In particular, the message text 32 in the e-mail message 50 can be extracted from the e-mail message using body processing component 60B. Likewise, header information such as the address of the sender and recipients, can be extracted from the e-mail message using header processing component 60C. Finally, attachments included in the e-mail message can be processed in the attachment processing component 60D.

As shown in FIG. 2, a voice conversation processor 60E can be provided for use in the e-mail client logic 60. The voice conversation processor 60E can detect the presence of the voice communications link identifier 56 encapsulated in the e-mail message 50. Responsive to detecting the voice communications link identifier 56, the voice conversation processing component 60E can cause the placement of a selectable icon 36 in the e-mail client 70. Subsequently, the selection of the selectable icon 36 can cause the establishment of a voice communications link between the sending node and the recipient node. Notably, the establishment of the voice communications link can be achieved through program code provided by the e-mail client 70, by a plug-in to the e-mail client, by the e-mail message 50 itself, or by remote code referenced by either the e-mail client 70 or the voice communications link identifier 56.

The identity information required to establish the voice communications link can be provided in the message header component 50A. Still, the invention is not limited in this regard and the message header component 50A can merely contain a reference to the sending node and optionally recipient nodes which, in of itself, can be inadequate to establish a voice communications link. In that case, the reference can be used to retrieve the required information. For example, the reference can act as a key to a directory lookup service such as an LDAP database. Using the key, suitable identity information can be retrieved, such as an IP address, with which a voice communications link can be established.

Though only a single selectable icon 36 is shown in FIG. 2, the invention is not limited solely to the establishment of a voice communications link between the sending and recipient nodes. Rather, based upon recipient information extracted from the message header component 50A, corresponding selectable icons can be provided. Responsive to the selection of a selectable icon, a voice communications link can be established between one or more corresponding recipient nodes. Furthermore, where multiple selectable icons are provided, a conference call can be established between nodes based upon the selection of corresponding selectable icons. Finally, conference calls can established for all sender/recipients, or for selected groups of sender/recipients, such as only those recipients in a given department.

The present invention can be realized in hardware, software, or a combination of hardware and software. Moreover, the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which when loaded in a computer system is able to carry out these methods. Computer program means or computer program in the present context means any expression, in any language, code or notation, of a set of instructions intended to cause a system having an information processing capability to perform a particular function either directly or after either or both of the following a) conversion to another language, code or notation; b) reproduction in a different material form.

Significantly, this invention can be embodied in other specific forms without departing from the spirit or essential attributes thereof, and accordingly, reference should be had to the following claims, rather than to the foregoing specification, as indicating the scope of the invention.

We claim:

1. An e-mail communication method comprising the steps of:
inserting in an e-mail message a voice communications identifier;
transmitting said e-mail message to a recipient; and,
responsive to said recipient selecting said voice communications identifier, establishing a voice communications link with said recipient.

2. The e-mail communication method of claim 1, wherein said inserting step further comprises the step of inserting in said e-mail message a selectable symbol denoting voice communications availability.

3. The e-mail communication method of claim 1, wherein said inserting step further comprises the step of:
inserting in said e-mail message a reference to a sender of said e-mail message; and,
embedding computer program code in said e-mail message, wherein said computer program code is configured to establish a voice communications link with said sender.

4. The e-mail communication method of claim 3, wherein said establishing step comprises the step of responsive to said recipient selecting said voice communications identifier, executing said embedded computer program code in order to establish a voice communications link with said sender.

5. The e-mail communication method of claim 3, wherein said establishing step comprises the steps of responsive to said recipient selecting said voice communications identifier, determining a link address for said sender based on said reference, and executing said embedded computer program code in order to establish a voice communications link with said sender according to said determined link address.

6. The e-mail communication method of claim 5, wherein said link address is a telephone number.

7. The e-mail communication method of claim 5, wherein said link address is an IP address.

8. The e-mail communication method of claim 1, wherein said establishing step comprises the step of responsive to said recipient selecting said voice communications identifier, establishing a Voice over IP (VoIP) based voice communications link with said recipient.

9. The e-mail communication method of claim 1, wherein said establishing step comprises the step of responsive to said recipient selecting said voice communications identifier, establishing a telephony-based voice communications link with said recipient over a public switched telephone network (PSTN).

10. An e-mail communication method comprising the steps of:
detecting a voice communications identifier in an e-mail message transmitted by a sender;
responsive to detecting said voice communications identifier, displaying a selectable icon; and,
responsive to a selection of said icon, establishing a voice communications link with said sender.

11. The e-mail communication method of claim 10, wherein said establishing step comprises the steps of:
extracting from said e-mail message embedded computer program code configured to establish a voice communications link with said sender; and,
responsive to said selection of said icon, executing said embedded computer program code in order to establish a voice communications link with said sender.

12. The e-mail communication method of claim 11, further comprising the step of extracting an embedded reference to said sender from said e-mail message.

13. The e-mail communication method of claim 12, wherein said executing step further comprises the steps of:
determining a link address for said sender based on said extracted reference; and,
executing said embedded computer program code in order to establish a voice communications link with said sender according to said determined link address.

14. The e-mail communication method of claim 13, wherein said link address is a telephone number.

15. The e-mail communication method of claim 13, wherein said link address is an IP address.

16. The e-mail communication method of claim 10, wherein said establishing step comprises the step of responsive to said recipient selecting said voice communications identifier, establishing a Voice over IP (VoIP) based voice communications link with said recipient.

17. The e-mail communication method of claim 10, wherein said establishing step comprises the step of responsive to said recipient selecting said voice communications identifier, establishing a telephony-based voice communications link with said recipient over a public switched telephone network (PSTN).

18. The e-mail communications method of claim 11, further comprising the steps of:
extracting from said e-mail message embedded references to said sender and at least one other recipient of said e-mail message; and,
displaying a corresponding selectable icon for each of said at least one other recipients.

19. The e-mail communication method of claim 18, further comprising the steps of:
responsive to a selection of one of said selectable icons, identifying a corresponding recipient and determining a link address for said corresponding recipient based on said extracted reference; and,
executing said embedded computer program code in order to establish a voice communications link with said corresponding recipient according to said determined link address.

20. The e-mail communication method of claim 18, further comprising the steps of:
responsive to a selection of two or more of said selectable icons, identifying a corresponding recipient for each selected icon and determining a link address for said corresponding recipients based on said extracted references; and,
executing said embedded computer program code in order to establish a conference call with said corresponding recipients according to said determined link addresses.

21. A machine readable storage having stored thereon a computer program having a plurality of code sections executable by a machine for causing the machine to perform the steps of:
inserting in an e-mail message a voice communications identifier;
transmitting said e-mail message to a recipient; and,
responsive to said recipient selecting said voice communications identifier, establishing a voice communications link with said recipient.

22. The machine readable storage of claim 21, wherein said inserting step further comprises the step of inserting in said e-mail message a selectable symbol denoting voice communications availability.

23. The machine readable storage of claim 21, wherein said inserting step further comprises the step of:
inserting in said e-mail message a reference to a sender of said e-mail message; and,
embedding computer program code in said e-mail message, wherein said computer program code is configured to establish a voice communications link with said sender.

24. The machine readable storage of claim 23, wherein said establishing step comprises the step of responsive to said recipient selecting said voice communications identifier, executing said embedded computer program code in order to establish a voice communications link with said sender.

25. The machine readable storage of claim 23, wherein said establishing step comprises the steps of responsive to said recipient selecting said voice communications identifier, determining a link address for said sender based on said reference, and executing said embedded computer program code in order to establish a voice communications link with said sender according to said determined link address.

26. The machine readable storage of claim 25, wherein said link address is a telephone number.

27. The machine readable storage of claim 25, wherein said link address is an P address.

28. The machine readable storage of claim 21, wherein said establishing step comprises the step of responsive to said recipient selecting said voice communications identifier, establishing a Voice over IP (VoIP) based voice communications link with said recipient.

29. The machine readable storage of claim 21, wherein said establishing step comprises the step of responsive to said recipient selecting said voice communications identifier, establishing a telephony-based voice communications link with said recipient over a public switched telephone network (PSTN).

30. An machine readable storage having stored thereon a computer program having a plurality of code sections executable by a machine for causing the machine to perform the steps of:
detecting a voice communications identifier in an e-mail message transmitted by a sender;
responsive to detecting said voice communications identifier, displaying a selectable icon; and,
responsive to a selection of said icon, establishing a voice communications link with said sender.

31. The machine readable storage of claim 30, wherein said establishing step comprises the steps of:
extracting from said e-mail message embedded computer program code configured to establish a voice communications link with said sender; and,
responsive to said selection of said icon, executing said embedded computer program code in order to establish a voice communications link with said sender.

32. The machine readable storage of claim 31, further comprising the step of extracting an embedded reference to said sender from said e-mail message.

33. The machine readable storage of claim 32, wherein said executing step further comprises the steps of:
determining a link address for said sender based on said extracted reference; and,
executing said embedded computer program code in order to establish a voice communications link with said sender according to said determined link address.

34. The machine readable storage of claim 33, wherein said link address is a telephone number.

35. The machine readable storage of claim 33, wherein said link address is an P address.

36. The machine readable storage of claim 30, wherein said establishing step comprises the step of responsive to said recipient selecting said voice communications identifier, establishing a Voice over IP (VoIP) based voice communications link with said recipient.

37. The machine readable storage of claim 30, wherein said establishing step comprises the step of responsive to said recipient selecting said voice communications identifier, establishing a telephony-based voice communications link with said recipient over a public switched telephone network (PSTN).

38. The e-mail communications method of claim 31, further comprising the steps of:
extracting from said e-mail message embedded references to said sender and at least one other recipient of said e-mail message; and,
displaying a corresponding selectable icon for each of said at least one other recipients.

39. The machine readable storage of claim 38, further comprising the steps of:
responsive to a selection of one of said selectable icons, identifying a corresponding recipient and determining a link address for said corresponding recipient based on said extracted reference; and,
executing said embedded computer program code in order to establish a voice communications link with said corresponding recipient according to said determined link address.

40. The machine readable storage of claim 38, further comprising the steps of:
responsive to a selection of two or more of said selectable icons, identifying a corresponding recipient for each selected icon and determining a link address for said corresponding recipients based on said extracted references; and,
executing said embedded computer program code in order to establish a conference call with said corresponding recipients according to said determined link addresses.

41. An electronic message article of manufacture for use in a computer communications network comprising:
a message header component encapsulating a reference to at least one of a sending node in the network and a recipient node in the network;
a text message component encapsulating message text which can be extracted from the electronic message and displayed in a message client; and,
an executable voice communications link program component configured to establish a voice communications link between said sending and recipient nodes.

42. The electronic message article of manufacture of claim 41, wherein said voice communications link is a Voice over IP (VoIP) based communications link.

43. The electronic message article of manufacture of claim 42, wherein said voice communications link is a telephony-based link

44. An e-mail client comprising:
a conventional e-mail processor, said conventional e-mail processor extracting and displaying message text encapsulated in a received e-mail; and,
a voice conversation processor, said voice conversation processor identifying a voice communications link identifier encapsulated in said received e-mail, displaying a selectable icon in response to detecting said voice communications link identifier and, responsive to a selection of said selectable icon, establishing a voice communications link with a sender of said received e-mail.
